(19) United States
(12) Patent Application Publication
(10) Pub. No.: US 2005/0264529 A1
(43) Pub. Date: Dec. 1, 2005

(54) Display method and system with select lighting to denote button action

(75) Inventors: Michael J. Morgan, Glendale, AZ (US); John J. Felton, Waltham, MA (US); Bruce A. Clarkson, Beverly, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avidyne Corporation, Lincoln, MA (US)

(21) Appl. No.: 11/118,757

(22) Filed: Apr. 29, 2005

Related U.S. Application Data
(60) Provisional application No. 60/566,781, filed on Apr. 30, 2004.

(51) Int. Cl. G09G 5/00; G09G 5/08

(52) U.S. Cl. 345/160; 345/172; 345/168

(57) ABSTRACT

Button action in a display system is dynamically denoted by either illuminating or not illuminating an illuminable element adjacent to the button to provide a lighting effect around the periphery of the button. The illumination of an illuminable element adjacent to an active button has the effect of drawing attention to an active button. Active buttons are dynamically updated based upon the state of the system and/or the particular page displayed.

### RELATED APPLICATION

This application claims the benefit of U.S. Provisional Application No. 60/566,781, filed on Apr. 30, 2004. The entire teachings of the above application are incorporated herein by reference.

### BACKGROUND OF THE INVENTION

Flight deck systems in aircraft typically include graphical display systems that integrate numerous elements of flight critical data—including Global Positioning System (GPS) navigation information, traffic information, lightning information, and terrain. The graphical display system displays this data on a screen of a display monitor and allows the pilot to overlay important navigation data such as the active flight plan route, airways, political boundaries, obstacles and special use airspace, over a color-contoured terrain and water base map. Standard flight instrumentation including attitude, heading, airspeed, altitude and vertical speed may also be displayed on the screen.

The graphical display system includes push buttons and adjustable knobs to allow the pilot to select modes or change the data that is displayed on the screen. Different data or screen views (pages) can be selected for display on the screen. The push buttons and knobs are mapped to different functions dependent on the page being displayed.

### SUMMARY OF THE INVENTION

The push buttons that are active for a particular page being displayed on the screen can be confusing to the pilot. To reduce potential confusion, each push button is seated within a recess and has an illuminable element adjacent to the push button. The illuminable element is separately controllable and is illuminated only if the push button is active for the displayed page, that is, if the push button is mapped to a selectable function for the displayed page. The illuminable element provides a lighting effect around the periphery of the button. This illumination of the active push button has the effect of drawing attention to the applicable push button and improves the ease of operation of the system.

A display system includes a screen and a plurality of push buttons, an illuminable element is adjacent to each push button to provide a lighting effect around the periphery of the button. The screen displays a page of information (screen view) that includes at least one selectable function mapped to one of the push buttons. Light is transmitted through the illuminable element adjacent to the one push button mapped to the one selectable function, to denote that the push button is active for the displayed page.

The illuminable element may be seated in a recess surrounding the push button. The push button may be in the shape of a rectangle having rounded corners. The page of information may include multiple selectable functions mapped to respective ones of the push buttons. The illuminable element of each of the respective ones of the push buttons becomes illuminated during display of the page. For different pages displayed on the display there are respective different selectable functions mapped to different ones of the push buttons. For each different page, during display of that page the illuminable elements of the ones of the push buttons that have selectable functions mapped thereto are illuminated. The illuminable element may be a light pipe or a pair of light emitting diodes.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a display system including a plurality of push buttons;

FIG. 2 is a block diagram of the display system 100 shown in FIG. 1 including a display routine which denotes active push buttons according to the principles of the present invention;

FIG. 3 illustrates a page displayed on the display system denoting active push buttons for the displayed page according to the principles of the present invention;

FIG. 4 illustrates another page displayed on the display system denoting active push buttons for the displayed page;

FIG. 5 is a flow chart illustrating a method implemented in the display controller for controlling the illumination of active push buttons according to the principles of the present invention;

FIG. 6 is a block diagram of an embodiment of the control circuit shown in FIG. 2;

FIG. 7 is a circuit diagram for a portion of the control circuit shown in FIG. 6; and

FIG. 8 illustrates the positioning of the light emitting diodes in the circuit shown in FIG. 6 around the push button.

### DETAILED DESCRIPTION OF THE INVENTION

A description of preferred embodiments of the invention follows.

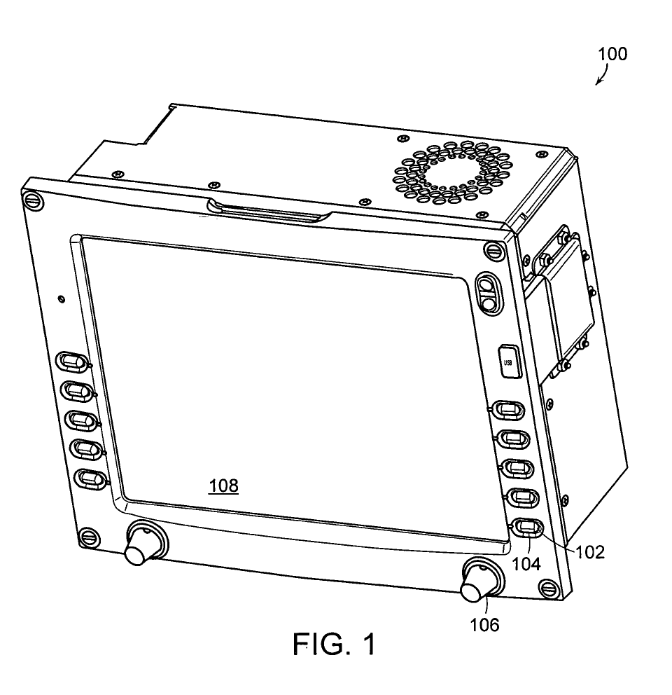

FIG. 1 is a perspective view of a display system 100 including a plurality of push buttons 102. The display system 100 also includes adjustment knobs 106 and a screen 108. The display system 100 includes a display which is an electronic device such as a Cathode Ray Tube (CRT) or liquid crystal display (LCD)-based or gas plasma-based flat panel display that temporarily presents information in visual form. The information is displayed on the screen 108 of the display system 100, that is, a surface of the display system on which the information appears. In display systems, the internal representation of a screenful of information displayed on the screen is typically referred to as a page. A page is a portion of display memory that contains one complete full-screen image. The push button 102 is a small actuator that when pushed closes an electric circuit. The closing of the electric circuit denotes selection of a function that is mapped to the push button 102.

Each push button 102 includes a recess surrounding the actuator or controller portion of push button 102 in which an illuminable element 104 is seated. In one embodiment, the illuminable element is a light pipe that is adjacent to the push button and surrounds the push button. A light pipe is a solid transparent plastic rod for transmitting light lengthwise. The light can be provided by a Light Emitting Diode (LED). The illumination of each illuminable element 104 is separately controlled. In alternate embodiments, other lighting techniques well known to those skilled in the art can be used for the illuminable element. For example, the illuminable element can include a pair of light emitting diodes positioned adjacent to the push button such that when both diodes are lit, a lighting effect is provided around the periphery of the push button.

The light is only transmitted by the illuminable element 104, if the push button 102 is active for the page displayed on the screen 108, that is, if the push button 102 is mapped to a selectable function for the page displayed on the screen 108.

In the embodiment shown, each of the push buttons 102 is in the shape of an oval or a rectangle having rounded corners. Printed circuit boards used for mounting push buttons and knobs in a display system are well known to those skilled in the art.

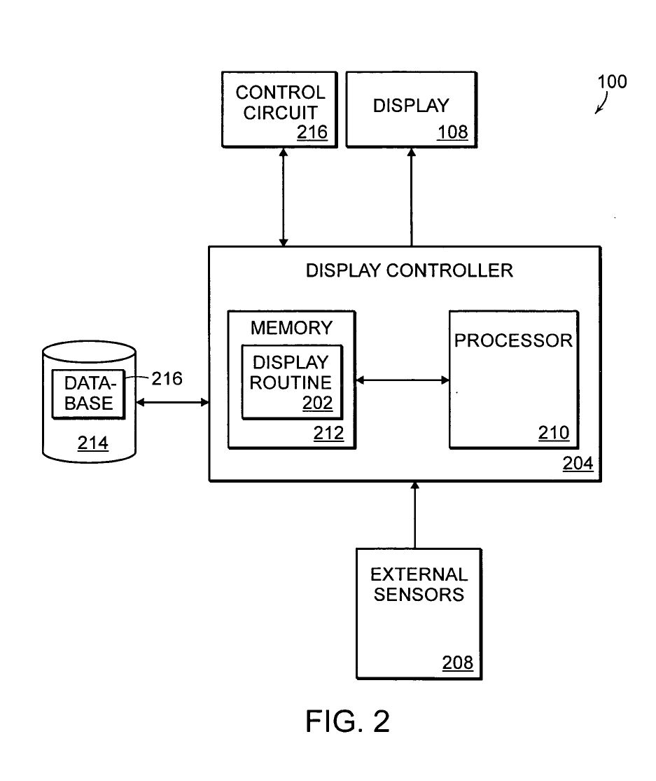

FIG. 2 is a block diagram of the display system 100 shown in FIG. 1 including a display routine 202 which denotes active push buttons according to the principles of the present invention. The display system 100 includes a display controller 204, screen 108 and external sensors 208. The display controller 204 includes a processor 210 and memory 212 for processing parameters received by the external sensors 208. The display controller 204 may also include a storage device 214 such as a disk or CD-ROM for storing a data base which stores parameters displayed on the screen 108.

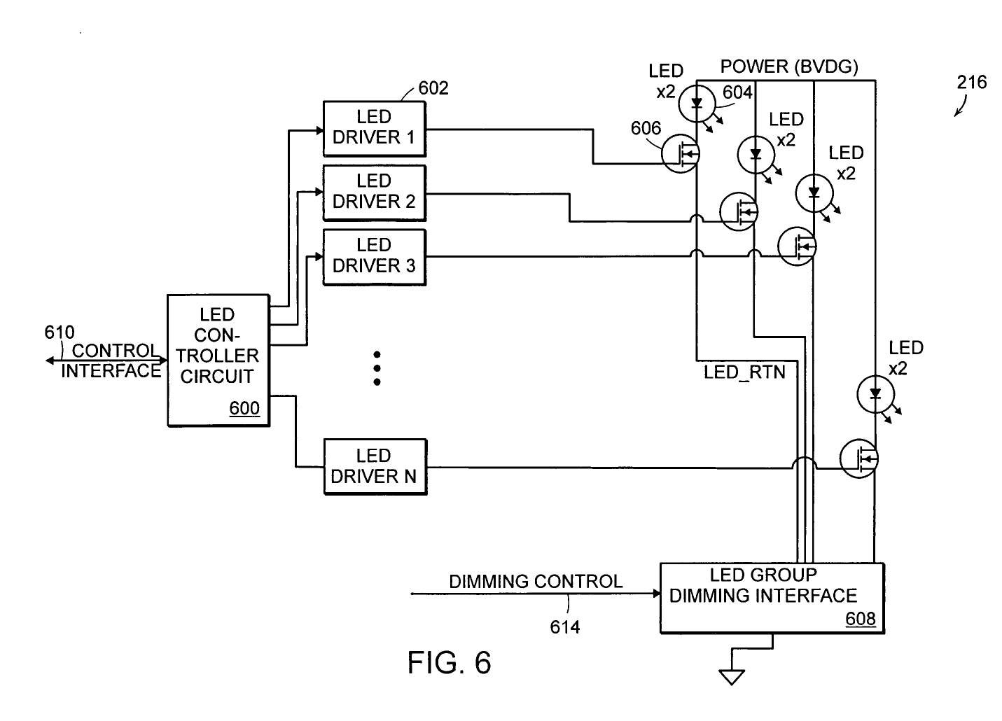

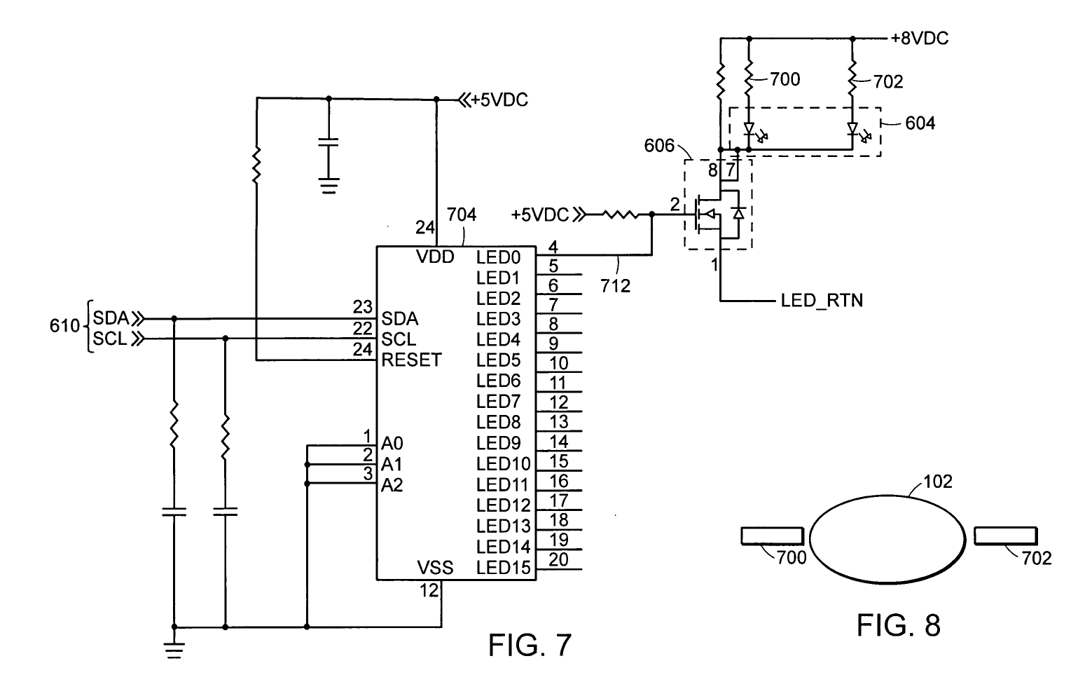

The display routine 202 controls the information displayed (displayed pages/screen view) on the screen 108 and the illumination of the illuminable elements 104 adjacent to push buttons 102 to denote active push buttons for the displayed page. The illumination of the illuminable element 104 adjacent to each push button 102 is controlled by the control circuit 216 for the active push buttons 102. An embodiment of the control circuit 216 will be described later in conjunction with FIGS. 6 and 7. The display routine 202 may also be stored in the storage device 214.

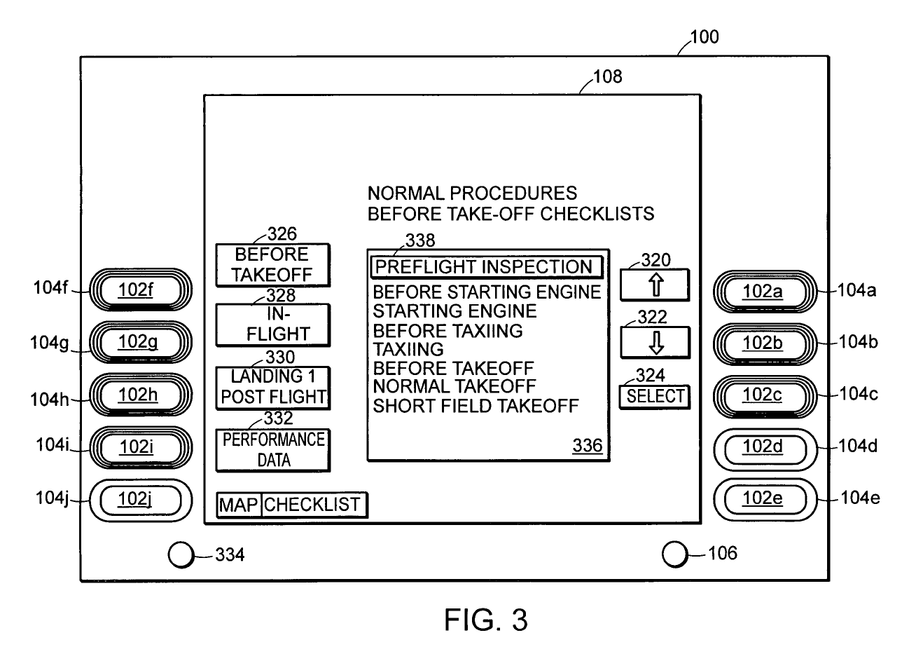

FIG. 3 illustrates a page displayed on the display system 100 denoting active push buttons for the displayed page according to the principles of the present invention. The display system includes ten push buttons 102a-j, five located on each side of the screen 108. Four push buttons 102f-i located at the left of the screen 108 are active as indicated by the illumination of the illuminable element 104f-i to provide a lighting effect around the periphery of each push button. Three push buttons 102a-c located at the right of the display are illustrated as active.

The checklist page is displayed on the screen 108. The checklist page includes a checklist menu 336. A menu is a list of options from which the user can make a selection in order to perform a desired action. The checklist menu 336 is a list of all the normal procedures checklists for each phase of flight. The first item in the checklist menu 336 is highlighted by a rectangular box 338. The checklist page also includes a label (description of the function) indicating the function that is mapped to each active push button 102a-c and 102f-i. The label is displayed at a position on the display screen that is adjacent to the respective push button 102. For example, push buttons 102a and 102b are mapped to functions that move the outlined box 338 up and down over the items in the menu 336.

Label 320 adjacent to push button 102a is an up arrow symbol that indicates that push button 102a is mapped to the function which moves the outlined box 338 to the item directly above the currently selected item in the list/menu 336. Label 322 adjacent to push button 102b is a down arrow symbol that indicates that push button 102b is mapped to the function which moves the outlined box 338 to the item in the menu 336 directly below the currently highlighted item in the menu 336. Label 324 adjacent to push button 102c includes the text “select” that indicates that push button 102c is mapped to the function that selects the currently highlighted item in the menu 336. Respective illuminable elements 104d, 104e adjacent to push buttons 102d, 102e are not illuminated indicating that the push buttons are not active for the current page (screen view) displayed on the screen 108. Also, there is no label displayed at positions on the screen 108 adjacent to non-active push buttons 102d, 102e.

The active push buttons 102f-102i on the left side of the screen 108 allow the pilot to select other checklists to be displayed on the screen 108. A label 326, 328, 330, 332 indicating the respective checklist that is mapped to each push button 102f-102i is displayed at a screen position adjacent to each push button 102. In the embodiment shown, all of the active push buttons remain active with the respective illuminable element 104 adjacent to each active push button to provide a lighting effect around the periphery of the push button while the checklist page is displayed on the screen 108.

Thus, push button action can be dynamically denoted by whether the illuminable element 104 adjacent to the push button 102 is illuminated. This draws attention to the push buttons that are active dependent on the state of the system and/or the page displayed on the screen 108 and thus improves the ease of operation of the system 100. Additional benefit is obtained by reducing clutter and overall ambient brightness in the cockpit of the aircraft by not illuminating the illuminable element adjacent to non-active push buttons 102.

The left knob 334 below the screen 108 controls the page that is displayed on the display screen. The left knob 334 provides access to the map page. In the embodiment shown, only two pages are available, the checklist page and the map page. However, in other embodiments, there may be more than two selectable pages.

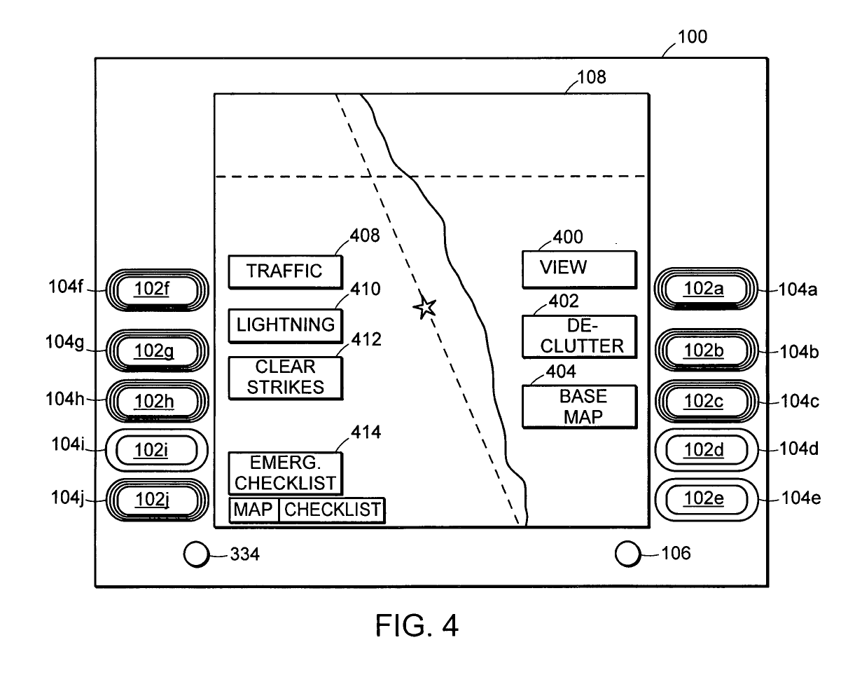

FIG. 4 illustrates another page (map page) displayed on the screen 108 of system 100 with only active push buttons 102a-c, 102f-102h and 102j illuminated by respective illuminable elements 104a-104c, 104f-104h and 104j. The map page provides a view of the flight situation based on input from external sensors 208 (FIG. 2) such as a global positioning system (GPS). The display controller 204 (FIG. 2) also uses information stored in the database 216 (FIG. 2) for mapping off-route navigational data such as nearby airports, special use and restricted airspace and terrain water and obstacles. The map page can display different levels of detail including contoured terrain, water features and political boundaries. The number of levels displayed is user selectable.

As shown, each active push button 102a-102c, 102f-102h and 102j has an associated label 400, 402, 404, 408, 410, 412 and 414 describing the function that is mapped to the push button (actuator). The labels displayed on the screen 108 and the active push buttons are different for each page displayed. As described in conjunction with the checklist page shown in FIG. 3, a label is only displayed on the screen 108 for an active push button and the illuminable element adjacent to a push button is only illuminated if the push button is active for the displayed page.

Referring to the map page shown in FIG. 4, push buttons 102a-c control the basic look of the map in terms of orientation, number of elements, and base map. The view line select button 102a associated with currently displayed label “view” 400 when selected orients the map for either forward view or center view in north-up, track-up or heading up orientation. The declutter line select button 102b associated with displayed label “de-clutter” 402 when selected allows the pilot to quickly choose from multiple levels of database navigation map detail.

Likewise, the base map function key (push button) 102c corresponds to the “base map” label 404 displayed in the current screen view 108. The base map function key (push button) 102c selects from multiple levels of map detail, starting with contoured terrain and water base map and political boundaries. Pressing (pushing) the button 102c removes contoured terrain, while leaving water and political boundary references. Pressing (pushing) the button 102c again views the flight plan.

Push buttons 102f-102h control overlay and modes of available sensors. The traffic button 102f associated with the displayed label “traffic” 408 cycles through traffic sensor modes displaying intruders. The lightning button 102g associated with label “lightning” 410 cycles through lighting sensor modes. The clear strikes button 102h associated with label “clear strikes” 412 removes lightning symbols to allow for the refresh of lightning data. Push button 102j associated with the label “emergency checklist” 414 allows the emergency checklist to be displayed with one-button access from the map page.

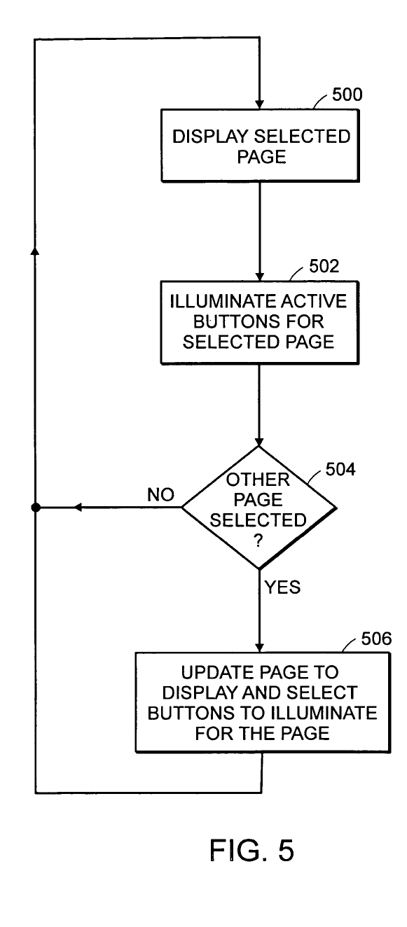

FIG. 5 is a flow chart illustrating a method implemented in the display controller 204 for controlling the illumination of push buttons 102 according to the present invention.

At step 500, the page selected by the left knob 334 (FIGS. 3 and 4) is displayed on the screen 108 (FIGS. 3 and 4). Labels indicating functions mapped to active push buttons are displayed in the areas of the screen view 108 close to the push buttons 102.

At step 502, the illuminable element 104 adjacent to each active push button 102 associated with the function labels displayed on the screen 108 is illuminated by the illumination control circuit to provide a lighting effect around the periphery of the push button, indicating that the push button 102 is active for the displayed page.

At step 504, the display routine 202 (FIG. 2) checks the state of the left knob 334 (FIGS. 3 and 4) to determine if the user has selected another page to be displayed. If so, processing continues with step 506 to display the new page and select the corresponding push buttons 102 to be illuminated. If not, processing continues with step 500 to continue to display the current page and illuminate the illuminable elements 104 adjacent to the active push buttons 102 for the current page.

At step 506, the display routine 202 updates the page to be displayed by retrieving information from the database 216 and updating the data to be displayed on the screen 108. The display routine 202 also selects the push buttons 102 to be illuminated based on the active push buttons for the newly selected page. Processing continues with step 500 to display the newly selected page.

FIG. 6 is a block diagram of an embodiment of the control circuit 216 shown in FIG. 2. The control circuit 216 includes a Light Emitting Diode (LED) controller circuit 600 for controlling a plurality of LED drivers 602, each LED driver 602 controls a pair of LED diodes 604 through a Field Effect Transistor 606 coupled between the LED driver 602 and the pair of LEDs 604. The pair of LEDs correspond to the illuminable element 104 shown in FIG. 1.

The LED controller circuit 600 receives commands from the processor 210 (FIG. 2) over a control interface 610. The LED controller 600 has a respective output control signal for each LED driver 602. One of the output signals from the LED driver is coupled to the gate of a Field Effect Transistor (FET) 606 to turn the FET ON when the output signal from the LED controller circuit to the LED driver 602 based on the command received from the processor indicates that the illuminable element 104 is to be illuminated. While the FET 606 is ON, the pair of LEDs are also ON and the illuminable element 104 is illuminated. Both LEDs 604 are lit to provide a uniform lighting effect around the periphery of the button 102. (FIG. 1) Each FET 606 is also coupled through a respective signal labeled LED_RTN to a LED group dimming interface 608. The LED group dimming interface 608 combines all of the LED_RTN signals to form an overall dimming signal that results in dimming all LEDs at the same time.

The LED group dimming interface 608 allows use of a secondary Pulse Width modulated signal to enhance the resolution of night time dimming. This allows sub one nit luminosity levels. The secondary pulse width modulated signal labeled “dimming control” 614 provides a greater resolution of the dimming range than that provided by the LED controller circuit 600 and LED driver 602. In the LED group dimming circuit, the secondary Pulse Width Modulated signal is applied to a MOSFET gate, whose drain and source are in series with the combined LED_RTN signal allowing software control of the dimming through the processor 210.

FIG. 7 is a circuit diagram of an embodiment of a portion of the control circuit 216 shown in FIG. 6. The control circuit 216 includes a pair of light emitting diodes (LEDs) 700, 702 corresponding to the pair of diodes 604 shown in FIG. 6. For simplicity, only one of the pairs of LEDs 604 is shown in FIG. 7.

The LED drivers 602 and LED controller circuit 600 shown in FIG. 6 are included in a single LED controller device (PCA9532PW) 704 manufactured by Philips Semiconductors. The device 704 is coupled through a control interface 610 to the processor 210. In the embodiment shown, the control interface is the I²C serial bus from Philips Semiconductor. The control interface includes a clock signal (SCL) and a data signal (SDA).

The output signal 712 from the LED controller device 704 is coupled to the gate of FET 606 to control whether LEDs 700, 702 are lit dependent on control signals received on the control interface 610 from the processor 210 over. While the FET 606 is ON, the pair of LEDs 700, 702 are lit and the illuminable element 104 is illuminated.

In one embodiment, the LEDs 700, 702 are manufactured by Toyoda Gosei, for example, part number E1S03-AC1A7-02 RANK P. However, any LED with an approximate 20 mA cathode current draw can be used.

FIG. 8 illustrates the positioning of the light emitting diodes in the circuit shown in FIG. 7 around the push button in the display system 100 shown in FIG. 1 on a printed circuit board. The pair of light emitting diodes 700, 702 shown in the circuit diagram in FIG. 6 are positioned at opposite ends of the button 102 on the printed circuit board and are both lit in order to provide a uniform lighting effect around the periphery of the button 102.

The illumination of an illuminable element 104 to provide a lighting effect around the periphery of the push button 102 can also be used to indicate the position of a focus point (cursor) on the display for use in display systems for helicopters. An illuminable element is illuminated dependent on the proximity of the cursor on the display to the illuminable element.

An embodiment of the invention has been described for a display system for use in the cockpit of an aircraft. However, the invention is not limited to aircraft display systems. The invention can be used in any display system having selectable functions mapped to push buttons.

1. A display system comprising:
a plurality of push buttons, an illuminable element adjacent to each push button to provide a lighting effect around the periphery of the button; and
a screen that displays a page of information including at least one selectable function mapped to one of the push buttons, light being transmitted through the illuminable element adjacent to the one push button mapped to the one selectable function to denote that the push button is active for the displayed page.

2. The display system of claim 1, wherein the illuminable element is seated in a recess surrounding the push button.

3. The display system of claim 1, wherein the one selectable push button is in the shape of a rectangle having rounded corners.

4. The display system of claim 1, wherein the page of information includes multiple selectable functions mapped to respective ones of the push buttons
the illuminable element of each of the respective ones of the active push buttons becomes illuminated during display of the page.

5. The display system of claim 1, wherein for different pages displayed on the display there are respective different selectable functions mapped to different ones of the push buttons.

6. The display system of claim 5, wherein for each different page, during display of that page the illuminable elements of the ones of the push buttons having a selectable functions mapped thereto, being illuminated.

7. The display system of claim 1, wherein the illuminable element is a light pipe.

8. The display system of claim 1, wherein the illuminable element is a pair of light emitting diodes.

9. A computer implemented method for denoting button action in a display system comprising the steps of:
displaying a page of information on a screen of the display system, the page including at least one selectable function mapped to one of a plurality of push buttons; and
transmitting light through an illuminable element adjacent to each push button to provide a lighting effect around the periphery of the one push button mapped to the one selectable function to denote that the push button is active for the displayed page.

10. The method of claim 9 wherein the illuminable element is seated in a recess surrounding the push button.

11. The method of claim 9 wherein the one selectable push button is in the shape of a rectangle having rounded corners.

12. The method of claim 9 wherein the page of information includes multiple selectable functions mapped to respective ones of the push buttons,
the illuminable element of each of the respective ones of the active push buttons becomes illuminated during display of the page.

13. The method of claim 9 wherein for different pages displayed on the display there are respective different selectable functions mapped to different ones of the push buttons.

14. The method of claim 13 wherein for each different page, during display of that page the illuminable elements of the ones of the push buttons having a selectable functions mapped thereto, being illuminated.

15. The method of claim 9, wherein the illuminable element is a light pipe.

16. The method of claim 9, wherein the illuminable element is a pair of light emitting diodes.

17. A display system comprising:
means for displaying a page of information on a screen of the display system, the page including at least one selectable function mapped to one of a plurality of push buttons; and
means for transmitting light through an illuminable element adjacent to each push button to provide a lighting effect around the periphery of the one push button mapped to the one selectable function to denote that the push button is active for the displayed page.
